(19) United States
(12) Patent Application Publication
(10) Pub. No.: US 2010/0167614 A1
(43) Pub. Date: Jul. 1, 2010

(54) MICROSPHERE PRESSURE SENSITIVE ADHESIVE COMPOSITION

(75) Inventors: Ying-Yuh LU, Woodbury, MN (US); Kelly S. ANDERSON, Houlton, WI (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/644,645

(22) Filed: Dec. 22, 2009

Related U.S. Application Data
(60) Provisional application No. 61/140,684, filed on Dec. 24, 2008.

(51) Int. Cl. B32B 27/36; C09J 133/08; B32B 27/12

(52) U.S. Cl. 442/151; 524/556; 428/355 AC; 428/344; 428/354

(57) ABSTRACT

The present disclosure provides an adhesive made from a reaction product of: (a) one or more polymerizable monomer selected from the group consisting of n-C₆ to n-C₁₄ (meth)acrylates derived at least in part from non-petroleum resources; (b) an initiator; (c) a polymeric stabilizer, wherein the reaction occurs in water to yield a microsphere adhesive. The microsphere adhesive can be formulated into a pressure sensitive adhesive composition that can be applied to various substrates such as paper and polymeric film to produce repositionable adhesive coated articles such as tapes, notes, flags, easels, and the like.

### PRIORITY CLAIM

This application claims priority to U.S. Provisional Application No. 61/140,684, filed Dec. 24, 2008.

### FIELD OF INVENTION

This invention relates to pressure-sensitive adhesive compositions, in particular, to pressure sensitive adhesive compositions comprising one or more polymerized monomer(s) derived at least in part from non-petroleum sources.

### BACKGROUND

Certain compositions of pressure sensitive adhesives (“PSAs”) are known to possess the following properties: (1) aggressive and permanent tack, (2) adherence with no more than finger pressure, (3) sufficient ability to hold onto a substrate, and (4) sufficient cohesive strength to be removed cleanly from the substrate when desired. Materials that have been found to function well as PSAs include polymers designed and formulated to exhibit the requisite viscoelastic properties resulting in a desired balance of tack, peel adhesion, and shear holding power. PSAs are typically characterized by being normally tacky at room temperature (e.g., 20° C.).

Microsphere adhesives have proven to be extremely useful for use in PSAs because they allow a PSA-bearing article to be repositionable, i.e., to be attached and re-attached to different surfaces multiple times. Thus, microsphere adhesives have been used in consumable products such as, but not limited to, repositionable notes, repositionable flags or index tabs, and repositionable easel pads. Important characteristics of microsphere PSAs include, e.g., cost, manufacturability, environmental impact, toxicity, and, of course, the above-noted adhesive properties. Typically, such adhesives comprise a reaction product of (a) a polymerizable monomer derived from petroleum-based resources, e.g., C₄ to C₁₄ alkyl(meth)acrylate, optionally a comonomer; (b) an initiator; and (c) a stabilizer, wherein the reaction occurs in water to yield a microsphere adhesive. Illustrative examples of such adhesives are disclosed in U.S. Pat. Nos. 5,571,617 (Cooprider et al.) and 5,714,237 (Cooprider et al.). Typically such monomers have been derived from petroleum-based sources.

The need exists for new adhesive compositions, and other products, that are made from renewable raw materials and provide desired performance.

### SUMMARY OF THE INVENTION

It has been found that highly desirable microsphere PSAs can be made by using monomers derived from non-petroleum resources. While microspheres used in PSAs for decades have relied on petroleum derived monomers, it has been found that microspheres made from certain non-petroleum derived monomers surprisingly result in excellent PSAs. In particular, the non-petroleum derived microspheres and PSAs made therefrom as described herein are cost effective, readily manufacturable, environmentally friendly (enabling reduction in use of petroleum-based feedstocks and reduction in emission of greenhouse gases), and have lower adhesion build to paper over an extended period of time as compared to petroleum derived microspheres. Thus, some of the advantages provided by the adhesive compositions of the invention include reduction in use of petroleum derived materials, reduction in emission of global warming gases, and improved adhesive performance.

The present invention provides a solution for making microsphere adhesives made from a reaction product of, among other components, at least one polymerizable monomer where at least a portion of the monomer is derived from a non-petroleum resource. Illustrative examples of non-petroleum resources from which suitable polymerizable monomers, e.g., n-C₆ to n-C₁₋₁₄ (meth)acrylates, can be derived include plant fats such as vegetable oils, e.g., coconut oil, palm kernel oil, etc., and animal fats such as tallow and lard. The microsphere adhesives can be mixed with other constituents to form a microsphere PSA composition that can then be applied to various substrates or backing to yield articles such as tapes, labels, notes, flags, and the like. Advantageously, articles containing the microsphere PSA composition described herein are repositionable.

In one aspect, the present invention provides an adhesive made from a reaction product comprising or consisting essentially of:
(a) one or more polymerizable monomer(s) derived at least in part from non-petroleum resources as described herein;
(b) one or more initiator(s); and
(c) one or more stabilizer(s),
   wherein the reaction occurs in water and wherein the adhesive is a microsphere adhesive. The stabilizer may include a polymeric stabilizer, a surfactant, and a combination of thereof.

In another aspect, the present invention pertains to an adhesive comprising or consisting essentially of a reaction product of:
(a) from about 92.0 to about 99.9 wt % of one or more n-C₆ to n-C₁₄ (meth)acrylates prepared by reacting (meth)acrylic acid with one or more n-C₆ to n-C₁₋₄ alcohols derived from a non-petroleum resource;
(b) from about 0.01 to about 4.0 wt % of polymeric stabilizer(s); and
(c) from about 0.01 to bout 4.0 wt % of initiator(s),
   wherein the wt % of each component is based on the total of components (a) to (c) and wherein the reaction occurs in water to yield a microsphere adhesive.

In yet another aspect, the present invention pertains to an adhesive comprising or consisting essentially of a reaction product of:
(a) from about 87 to about 99.9 wt % of one or more n-C₆ to n-C₁₋₁₄ (meth)acrylates prepared by reacting (meth)acrylic acid with one or more n-C₆ to n-C₁₋₄ alcohols derived from a non-petroleum resource;
(b) from about 0.01 to 5 wt % of one or more surfactant(s);
(c) from about 0.01 to 4 wt % of one or more polymeric stabilizer(s); and
(d) from about 0.01 to 4 wt % of one or more initiator(s);
   wherein the wt % of each component is based on the total of components (a) to (d), with optionally, per 100 parts by weight of component (a) one or more of the following;
(e) up to about 75 parts by weight of one or more alkyl(meth)acrylate comonomer(s) having from about 1 to 14 carbon atoms;
(f) less than about 5 parts by weight of one or more polar comonomer(s);
(g) up to about 10 parts by weight of one or more amido comonomer(s);
(h) up to about 10 parts by weight of one or more polyethylene oxide (meth)acrylate(s);
(i) up to about 30 parts by weight of one or more solute polymer(s);
(j) up to about 0.2 parts by weight of one or more chain transfer agent(s);
(k) up to about 5 parts by weight of one or more ionic monomer(s); and
(l) up to about 1 parts by weight of one or more crosslinker(s),
   wherein the reaction occurs in water to yield a microsphere adhesive.

### DETAILED DESCRIPTION OF ILLUSTRATIVE EMBODIMENTS

All numbers are herein assumed to be modified by the term “about.” The recitation of numerical ranges by endpoints includes all numbers subsumed within that range (e.g., 1 to 5 includes 1, 1.5, 2, 2.75, 3, 3.80, 4, and 5).

As used herein, the term “non-petroleum” refers generally to a compound for which crude oil or its derivatives are not the ultimate raw material (i.e., starting material). An exemplary non-petroleum resource includes, but is not limited to, biobased resources, such as those derived from plants. As used herein, an article is “repositionable” if it can be attached to and removed from display surfaces multiple times without leaving adhesive residue upon the intended display surface and/or damaging surfaces. As used herein the term (meth)acrylate includes acrylate and methacrylate.

To determine if a polymerizable monomer contains biobased content so that it is considered non-petroleum, one can use ASTM D 6866-06a, Standard Test Methods for Determining the Biobased Content of Natural Range Materials Using Radiocarbon and Isotope Ratio Mass Spectrometry Analysis. As described herein, adhesive compositions of the present invention can be made which have biobased carbon content of at least about 30%, preferably at least about 40%, and most preferably at least about 50%, and in some embodiments, of at least about 65% as determined in accordance with this ASTM. The “biobased carbon content” refers to the proportion of total carbon in the composition that originates through use of biologically produced feedstocks, e.g., monomer materials derived from fermentation of plant matter or extracted from plants directly, as opposed to being derived from petroleum sourced materials such as the alkyl(meth)acrylates that are derived from petroleum sources.

Polymerizable Monomer(s)

We have discovered that microsphere PSAs can be made using one or more polymerizable monomers derived from non-petroleum or biobased resources, e.g., plant fats or animal fats and that such adhesive compositions provide surprising results.

One illustrative class of examples of suitable polymerizable monomers derived from non-petroleum resources that may be used herein includes n-C₆ to n-C₁₄ (meth)acrylates, wherein the n-C₆ to n-C₁₄ (meth)acrylates including, e.g., n-hexyl(meth)acrylate, n-heptyl(meth)acrylate, n-octyl(meth)acrylate, n-decyl(meth)acrylate, n-dodecyl(meth)acrylate and n-tetradecyl(meth)acrylate are prepared by reacting (meth)acrylic acid with n-hexanol, n-heptanol, n-octanol, n-decanol, n-dodecanol and n-tetradecanol, respectively. Illustrative examples of plant fats from which polymerizable monomers for use herein can be made include coconut oil and palm kernel oil. Illustrative examples of animal fats from which polymerizable monomers for use herein can be made include tallow and lard.

The n-C₆, n-C₈, n-C₁₀, and n-C₁₄ alcohols with even numbered carbon chain length can be derived from vegetable oils such as coconut oil and palm kernel oil, as described in Kirk-Othmer Encyclopedia of Chemical Technology, Alcohols, Higher Aliphatic, Survey and Natural Alcohols Manufacture, John Wiley & Sons, Inc. If desired, alcohols with odd numbered carbon chain lengths for use herein can be made by modification of the naturally occurring even numbered raw materials, e.g., by steam cracking, ozonolysis, etc. of biobased fatty acids.

If desired, mixtures of two or more such polymerizable monomers may be used to make adhesives of the invention. Also the biobased polymerizable monomer component used in adhesives of the invention may be derived from two or more non-petroleum resources.

Polymeric Stabilizer(s)

One or more polymeric stabilizers are used in the reaction mixture to prepare the microsphere adhesive. Advantageously, the presence of the stabilizer permits the use of relatively low amounts of surfactants while still obtaining microspheres.

Any polymeric stabilizer that effectively provides sufficient stabilization of the final polymerized droplets and prevents agglomeration within a suspension polymerization process is useful in this disclosure. When used, the polymeric stabilizer component(s) will typically be present in the reaction mixture in a total amount by weight of about 0.01 to about 4 parts by weight per 100 parts of polymerizable monomer(s), and in some embodiments will be present in an amount by weight of about 0.04 to about 1.5 parts by weight per 100 parts of polymerizable monomer(s).

Suitable polymeric stabilizers include, but are not limited to, salts of polyacrylic acids of greater than 5000 weight average molecular weight average (e.g., ammonium, sodium, lithium and potassium salts), carboxy modified polyacrylamides (e.g., CYANAMER® A-370 from American Cyanamid), copolymers of acrylic acid and dimethylaminoethylmethacrylate and the like, polymeric quaternary amines (e.g., General Alanine and Film's GAFQUAT® 755, a quaternized polyvinyl-pyrollidone copolymer, or Union Carbide's “JR-400”, a quaternized amine substituted cellulosic), cellulosics, and carboxy-modified cellulosics (e.g., Hercules' NATROSOL® CMC Type 7L, sodium carboxy methylcellulose), and polyacrylamide (e.g., CYANAMER N300 from Cytek).

Initiator(s)

One or more initiators are used in the reaction mixture to prepare the microsphere adhesive. Initiators affecting polymerization are those that are normally suitable for free-radical polymerization of the polymerizable monomers. Illustrative examples of suitable initiators include, but are not limited to, thermally-activated initiators such as azo compounds, hydroperoxides, peroxides and the like. Suitable photoinitiators include, but are not limited to, benzophenone, benzoin ethyl ether and 2,2-dimethoxy-2-phenyl acetophenone. Other suitable initiators include lauroyl peroxide and bis(t-butyl cyclohexyl)peroxy dicarbonate.

The initiator(s) is present in a catalytically effective amount sufficient to bring about high monomer conversion in a predetermined time span and temperature range. Typically, the initiator component(s) is/are present in total amounts ranging from 0.01 to approximately 4 parts per weight per 100 parts by weight of the polymerizable monomer(s). Parameters that affect the concentration of initiator(s) used include the type of initiator(s) and particular monomer(s) involved. Depending upon the embodiment, catalytically effective total initiator concentrations will typically range from about 0.03 to about 2 parts by weight and, in some embodiments, from about 0.05 to about 0.50 parts by weight per 100 parts of the polymerizable monomer(s).

Surfactant(s)

One or more surfactant(s) may be used in the reaction mixture to prepare the microsphere adhesive, e.g., to facilitate achieving desired particle size. As will be understood by those skilled in the art, the surfactant(s) will typically be present in the reaction mixture in a total amount up to about 5 parts by weight per 100 parts by weight of polymerizable monomer(s) content, sometimes up to about 3 parts by weight, and in some embodiments in the range of 0.2 to 2 parts by weight per 100 parts by weight of polymerizable monomer(s).

Useful surfactants include anionic, cationic, nonionic or amphoteric surfactants. Useful anionic surfactants include, but are not limited to, alkyl aryl sulfonates, e.g., sodium dodecylbenzene sulfonate and sodium decylbenzene sulfate, sodium and ammonium salts of alkyl sulfates, e.g., sodium lauryl sulfate, and ammonium lauryl sulfate. Useful nonionic surfactants include, but are not limited to, ethoxylated oleoyl alcohol and polyoxyethylene octylphenyl ether. Useful cationic surfactants include, but are not limited to, a mixture of alkyl dimethylbenzyl ammonium chlorides wherein the alkyl chain contains from 10 to 18 carbon atoms. Useful amphoteric surfactants include, but are not limited to, sulfobetaines, N-alkylaminopropionic acids, and N-alkybetaines.

Chain Transfer Agent(s)

Depending upon the desired application, one or more modifier(s) may be used to regulate the solvent soluble portion (percent extractable) of the microspheres and to control properties of the resultant adhesive composition. As will be understood by those skilled in the art, if used, such agents are often added to the reaction mixture in an amount sufficient to provide a solvent soluble portion that is in the range of 10 to 98%, preferably in the range of 20 to 80%. Various modifiers may be used. The amounts used are those that sufficiently provide the microspheres with a solvent soluble portion.

Particularly useful modifiers are chain transfer agents. To control the molecular weight of the polymer being formed in the microsphere it is desirable to use a chain transfer agent. Many halogen- and sulfur-containing organic compounds function well as chain transfer agents in free radical polymerizations. Non-limiting examples of such agents are: carbon tetrabromide, carbon tetrachloride, dodecanethiol, iso-octylthioglycolate, butyl mercaptan, and tertiary-dodecyl mercaptan. The amount of chain transfer agent suitable for these microsphere polymerizations is calculated on a weight basis to the entire polymerizable content. When used, chain transfer agents are typically added at amounts totaling up to about 0.2%, in some embodiments totaling up to about 0.12%, and in still other embodiments totaling up to about 0.08%, of the amount of polymerizable monomer. These levels are adequate to provide a soluble polymer content in the microsphere of up to about 98%.

Crosslinking Agent(s)

One or more crosslinking agent(s) may be used in the reaction mixture to modify the properties of the resultant adhesive if desired as will be understood by those skilled in the art. Nonlimiting examples of suitable crosslinking agents include multifunctional (meth)acrylate(s), e.g., butanediol diacrylate or hexanediol diacrylate, or other multifunctional crosslinkers such as divinylbenzene and mixtures thereof. When used, crosslinker(s) is/are added at a total level of up to about 1 equivalent weight percent, preferably up to about 0.5 equivalent weight percent, of the total reaction mixture with the proviso that the combination of crosslinking agent and modifier concentrations are chosen to obtain a microsphere with 10 to 98% solvent soluble portion.

Polymerizable Comonomer(s)

The reaction mixture can further include polymerizable comonomers including the following: alkyl(meth)acrylates where the alkyl group contains 1 to 14 carbon atoms, vinyl ester monomers, ionic monomers, polar monomers, amino-functional monomers, amido-functional monomers, and monomers having an OH functional group. Each type of polymerizable comonomers, whether derived from a petroleum or non-petroleum resource, is further described in detail below.

Depending upon the desired results, up to 20 wt %, in some embodiments up to 50 wt %, and in still other embodiments up to 75 wt %, based on the n-C₆ to n-C₁₄ (meth)acrylates content, of alkyl(meth)acrylate can be used. Suitable alkyl(meth)acrylates include, but are not limited to isooctyl acrylate, isononyl(meth)acrylate, isoamyl(meth)acrylate, isodecyl(meth)acrylate, 2-ethylhexyl acrylate, n-butyl(meth)acrylate, sec-butyl(meth)acrylate, propyl(meth)acrylate, ethyl(meth)acrylate, methyl(meth)acrylate, isobornyl(meth)acrylate, 4-methyl-2-pentyl(meth)acrylate, 2-methylbutyl(meth)acrylate, t-butyl(meth)acrylate, and mixtures thereof.

When used in the reaction mixture to produce the microsphere adhesive, depending upon the desired properties, up to 0.5 wt %, in some embodiments up to 2 wt %, and in some other embodiments up to 5 wt %, based on the n-C₆ to n-C₁₄ (meth)acrylate content, of polar comonomer can be used. The polar comonomer may or may not contain a dissociable hydrogen. Nonlimiting examples of polar comonomers include organic carboxylic acids having 3 to about 12 carbon atoms and having generally 1 to about 4 carboxylic acid moieties, and hydroxyl(alkyl)(meth)acrylates. Nonlimiting examples of such comonomers include itaconic acid, fumaric acid, crotonic acid, maleic acid, beta-carboxyethylacrylate, acrylamide, methacrylamide, 2-hydroxyethyl(meth)acrylate, 4-hydroxybutyl(meth)acrylate, and glyercol mono(meth)acrylate. While (meth)acrylic acid can be used a polar comonomer, typically less than 0.5% is used in the reaction product. When more than 0.5% of the (meth)acrylic acid is used in the reaction mixture, coagulation problems typically arise.

When used in the reaction mixture to produce the microsphere adhesive, up to 20 wt %, based on the n-C₆ to n-C₁₄ (meth)acrylate content, of a vinyl or vinyl ester comonomer can be used. Nonlimiting examples of vinyl ester comonomers include vinyl 2-ethylhexanoate, vinyl caprate, vinyl laurate, vinyl pelargonate, vinyl hexanoate, vinyl propionate, vinyl decanoate, vinyl actanoate, vinyl acetate and other monofunctional unsaturated vinyl esters of linear or branched carboxylic acids comprising 1 to 14 carbon atoms. Nonlimiting examples of vinyl comonomer include styrene and alpha-methylstyrene.

When used in the reaction mixture to produce the microsphere adhesive depending upon the desired properties, up to 1 wt %, in some embodiments up to 2 wt %, and in some other embodiments up to 5 wt %, based on the n-C₆ to n-C₁₋₁₄ (meth)acrylate content, of an ionic comonomer can be used. Nonlimiting examples of ionic comonomers include sodium styrene sulfonate, sodium(meth)acrylate, ammonium(meth)acrylate, trimethylamine p-vinyl benzimide, 4,4,9-trimethyl-4-azonia-7-oxo-8-oxa-dec-9-ene-1-sulphonate, N,N-dimethyl-N-(beta-methacryloxyethyl)ammonium propionate betaine, trimethylamine methacrylimide, 1,1-dimethyl-1(2,3-dihydroxypropyl)amine methacrylimide, any zwitterionic monomer, and the like.

When used in the reaction mixture to produce the microsphere adhesive, up to 5 wt %, based on the n-C₆ to n-C₁₄ (meth)acrylate content, of an amino functional comonomer can be used. Nonlimiting examples of amino functional comonomer include N,N-dimethyl-aminoethyl(methyl)acrylate, N,N-dimethylaminopropyl(meth)acrylate, t-butylaminoethyl (methyl)acrylate and N,N-diethylamino(meth)acrylate.

When used in the reaction mixture to produce the microsphere adhesive depending upon the desired properties, up to 5 wt %, in some embodiments up to 8 wt %, and in some other embodiments up to 10 wt %, based on the n-C₆ to n-C₁₋₁₄ (meth)acrylate content, of an amido functional comonomer can be used. Nonlimiting examples of amido functional comonomer include N-vinyl pyrrolidone, N-vinyl caprolactum, acrylamide, N,N-dimethyl acrylamide, and combinations thereof.

When used in the reaction mixture to produce the microsphere adhesive depending upon the desired properties, up to 5 wt %, in some embodiments up to 8 wt %, and in some other embodiments up to 10 wt %, based on the n-C₆ to n-C₁₋₁₄ (meth)acrylate content, of one of the following polymerizable comonomer can be used: 2-hydroxyethyl (meth)acrylate, glycerol mono(meth)acrylate and 4-hydroxybutyl(meth)acrylate, (meth)acrylate terminated poly(ethylene oxide); methoxy poly(ethylene oxide)methacrylate; butoxy poly(ethylene oxide) methacrylate; (meth)acrylate terminated poly(ethylene glycol); methoxy poly(ethylene glycol) methacrylate; butoxy poly(ethylene glycol) methacrylate, and combinations thereof.

Typically, when the polymerizable comonomer is present in the reaction mixture, the relative amounts by weight of the n-C₆ to n-C₁₄ (meth)acrylate monomer(s) and the polymerizable comonomer is in the range of about 99.5/0.5 to 25/75, and preferably is in the range of 98/2 to 50/50.

Solute Polymer(s)

Another component that may be added to the reaction product to prepare the microsphere adhesive is one or more solute polymer(s) as described in detail in U.S. Pat. No. 5,824,748 (Kesti et al.).

A solute polymer, which is essentially water insoluble may be comprised of any monomer or mixture of monomers that upon polymerization provides a polymer that can be dissolved into the n-C₆ to n-C₁₄ (meth)acrylate monomer or a mixture of n-C₆ to n-C₁₄ (meth)acrylate monomer and the polymerizable comonomers described above. Typically, solute polymers have a weight average molecular weight (Mw) of at least 2000.

The solute component is comprised of various classes of polymers. For example, the solute polymer may be branched or linear polymer chains. The solute polymer may be prepared using water reactive or water soluble monomers, monomers that are not free-radically polymerizable, and combinations thereof. Furthermore, the solute polymers may be prepared according to any polymerization method that may be known to those skilled in the art and can be generally found in various references such as “Principles of Polymerization” Odian, 3rd ed., Wiley Interscience.

Nonlimiting examples of useful solute polymers include poly(acrylates), poly(methacrylates), poly(styrene), elastomers such as rubbers (natural and or synthetic) or styrene-butadiene block copolymers, polyurethanes, polyureas, polyesters, crystalline and non-crystalline polymers such as crystalline and non-crystalline poly-alpha-olefins, crystalline poly(methacrylate) and crystalline poly(acrylate), and mixtures thereof.

Advantageously, this disclosure provides a composite microsphere PSA that can incorporate moieties that normally react in the water phase when used in monomeric forms prior to suspension polymerization of such monomers. Nonlimiting examples of solute polymers comprised of such water reactive moieties include, but are not limited to polymers containing maleic anhydride, itaconic anhydride, 2-vinyl-4,4-dimethyl-2-oxazoline-5-one (VDM) and 2-(isocyanato)ethyl methacrylate.

Furthermore, highly water soluble moieties such as (meth)acrylic acid, N-vinyl pyrrolidone, (meth)acrylamide, poly(ethylene)oxide macromonomer, (meth)acrylimide, 1,1-dimethyl-1(2-hydroxylpropyl)amine methacrylimide, 1,1,1-trimethylamine methacrylimide, 1,1-dimethyl-1(2,3-dihydroxypropyl)amine methacrylimide, and other water soluble moieties, such as N,N-dimethyl-N-(beta-methacryloxyethyl)ammonium propionate betaine, 4,4,9-trimethyl-4-azonia-7-oxo-8-oxa-dec-9-ene-1 sulfonate, sodium (meth)acrylate, ammonium (meth)acrylate, and maleic anhydride, for example can also be incorporated into the solute polymer used in the preparation of the composite pressure sensitive adhesive microspheres, provided that the solute polymer is essentially water insoluble.

Suspension Polymerization Process

The microsphere adhesives of the present disclosure are prepared by suspension polymerization. Suspension polymerization is a procedure wherein a monomer is dispersed in a medium (usually aqueous) in which it is insoluble. The polymerization is allowed to proceed within the individual monomer droplets. Monomer soluble free-radical initiators are preferably used. The kinetics and the mechanism are those for the corresponding bulk polymerization under similar conditions of temperature and initiator concentration.

To initiate the polymerization reaction, a sufficient number of free radicals are present. This may be achieved through several means, such as heat or radiation free-radical initiation. For example, heat or radiation can be applied to initiate the polymerization of the monomers, which results in an exothermic reaction. However, it is preferred to apply heat until thermal decomposition of the initiators generates a sufficient number of free radicals to begin the reaction. The temperature at which this occurs varies greatly depending upon the initiator used.

In addition, deoxygenation of the polymerization reaction mixture is often desirable. Oxygen dissolved in the reaction mixture can inhibit polymerization and it is desirable to expel this dissolved oxygen. Although, an inert gas bubbled into the reaction vessel or through the reaction mixture is an effective means of deoxygenation, other techniques for deoxygenation that are compatible with suspension polymerization can be used. Typically, nitrogen is used to deoxygenate, although any of the Group VIIIA (CAS version) inert gases are also suitable.

While specific time and stirring speed parameters are dependent upon monomers, and initiators, it may be desirable to pre-disperse the reaction mixture until the reaction mixture reaches a state where the average monomer droplet size is between about 1 and 300 micrometer, and preferably between 20 and 75 micrometer. The average particle size tends to decrease with increased and prolonged agitation of the reaction mixture.

Preferably, stirring and nitrogen purge are maintained throughout the reaction period. Initiation begins by heating the reaction mixture. Following polymerization, the reaction mixture is cooled.

In a one-step process both the n-C₆ to n-C₁₄ (meth)acrylate and any optional other polymerizable comonomer are present together in the suspension at the initiation of polymerization. The other components, such as the initiator, stabilizers, surfactants (if used) and modifiers are present in the reaction mixture.

Following polymerization, a stable aqueous suspension of microspheres at room temperature is obtained. The suspension may have non-volatile solids contents of from about 10 to about 70 percent by weight. The aqueous suspension of microspheres may be used immediately following polymerization because the suspension of microspheres is particularly stable to agglomeration or coagulation. The microspheres can be coated from an aqueous solution by a conventional coating techniques such as slot die coating to provide an adhesive coating.

The microspheres can be compounded with various rheology modifiers and/or latex adhesives or “binders”. Typically, the adhesive coating which, when dried, exhibits a dry coating weight in the range of 0.2 to about 2 grams per square foot to provide an adhesive-coated sheet material in which the adhesive coating comprises polymeric microspheres, polymeric stabilizer, surfactant, and optionally rheology modifiers, and/or latex binder.

Properties of the microsphere PSAs of the present disclosure can be altered by the addition of a tackifying resin(s) and/or plasticizer(s) after the polymerization. Preferred tackifiers and/or plasticizers for use herein include hydrogenated rosin esters commercially available from such companies as Hercules, Inc. under the trade names of FORAL®, REGALREZ® and PENTALYN®. Tackifying resins also include those based on t-butyl styrene. Useful plasticizers include but are not limited to dioctyl phthalate, 2-ethylhexyl phosphate, tricresyl phosphate, alkyl citrates, and the like. If such tackifiers and/or plasticizers are used, the amounts used in the adhesive mixture are amounts effective for the known uses of such additives.

Optionally, modifiers such as rheology modifiers, colorants, fillers, stabilizers, pressure-sensitive latex binders and various other polymeric additives can be utilized. If such modifiers are used, the amounts used in the adhesive mixture are amounts effective for the known uses of such modifiers.

Substrates

Suitable backing or substrate materials for use in the present invention include, but are not limited to, paper, plastic films, cellulose acetate, ethyl cellulose, woven or nonwoven fabric comprised of synthetic or natural materials, metal, metallized polymeric film, ceramic sheet material and the like. In many embodiments, the backing or substrate material is 50 to 155 micrometer in thickness, although thicker and thinner backing or substrate materials may be used if desired. Typically the microsphere PSA composition will be applied or coated to at least a portion of a first side of the substrate. In some embodiments, a release coating is applied to a second side of the substrate generally in an area opposing that of the microsphere PSA.

Applications

Particularly useful articles prepared using the microsphere adhesives of the present invention include repositionable adhesive products such as repositionable note and paper products, repositionable tape and tape flags, easel sheets, repositionable glue stick and the like, but may also include other non-repositionable industrial commercial, and medical adhesive products.

### EXAMPLES

The invention will be further explained with the following illustrative examples and comparative examples.

### Test Methods

The following test methods were used to evaluate the performance of the microsphere PSA of Examples 1 to 4 and Comparative Example 1.

Adhesion to Bond Paper

Peel adhesion is the force required to remove a coated sheet from a bond paper substrate at a specific angle and rate of removal. In the examples this force is expressed in grams per one inch width of coated sheet. The procedure followed is:

A strip, one inch (2.54 cm) wide, of coated sheet (i.e., a sample) is applied to the horizontal surface of 20 pound (9.1 kg) bond paper. A 4.5 pound (2.0 kg) hard rubber roller is used to firmly apply the strip to the bond paper. The free end of the coated sheet is attached to the adhesion tester load cell such that the angle of removal will be 90°. The test plate is then clamped in the jaws of the tensile testing machine which is capable of moving the plate away from the load cell at a constant rate of 12 inches (30.5 cm) per minute. A load cell reading in grams per inch of coated sheet is recorded. The test was repeated and the data is reported as the average of the number of 3 trials.

Aged Adhesion to Bond Paper:

A one inch (2.5 cm) wide strip of coated sheet is applied to the horizontal surface of 20 pound bond paper. A 4.5 pound (2 kg) hard rubber roller is used to firmly apply the strip to the bond paper. The laminates were aged at 70° F. (21° C.) and 80% relative humidity for 72 hours. After aging, peel adhesion of the samples was performed according to the test method of Adhesion to Bond Paper described above.

Tack:

A TA-XT2i Texture Analyser made by Texture Technologies Corp. is used for the tack measurement. The specimen is held adhesive side up by a brass test fixture. A 7 mm stainless steel probe is brought into contact with the specimen until a specified force is reached, usually 100 g. After one second contact time, the probe is raised at speed of 0.5 mm/sec and the force of adhesion is measured as a function of the distance of the probe from the specimen. The tack is the peak removal force.

### Examples 1 to 4 and Comparative Example C1

Renewable microsphere adhesives of Example 1 to 4 were prepared in water by a suspension polymerization process. To prepare the renewable microsphere adhesives of Examples 1 to 4, the ingredients indicated in Table 1 were charged into a 4 neck flask equipped with a reflux condenser, thermometer, stirrer, and a nitrogen gas inlet. The mixture was then mixed at 350 rpm for 30 minutes to achieve a desired monomer droplet size of around 40 to 60 um. Once the monomer droplet size is in the specification as determined by an optical microscopy, the suspension was heated to an initiation temperature of 45° C. under a nitrogen atmosphere to initiate the polymerization. The reaction was allowed to exotherm. After polymerization, the batch was cured at 80° C. for 5 hours and then cooled to room temperature and filtered through a cheese cloth to remove coagulum if exists. Particle sizes of the Example 1 to 4 were 56 um, 53 um, 60 um, and 61 um, respectively, measured by a particle size analyzer, Horiba LA910. % extractable (i.e., % soluble polymer extracted by ethylacetate solvent in microsphere adhesive) of Examples 1 to 4 were 30%, 38%, 28%, and 24%, respectively. A Petroleum based monomer, 2-ethyl hexyl acrylate, 2EHA, was also used to make a microsphere adhesive (“MSA”) for comparison. To prepare the 2EHA microsphere adhesive of Comparative Example C1, the ingredients indicated in Table 1 and the above polymerization process were used. The resulting microsphere adhesive of the Comparative Example C1 has particle size of 46 um and % extractable of 42%.

TABLE 1
Polymerization formulations of Examples 1 to 4 and Comparative Example C1

| | | Example | | | | |
|---|---|---|---|---|---|---|
| Function of | | 1 | 2 | 3 | 4 | C1 |
| Ingredients | Ingredient | (grams) | (grams) | (grams) | (grams) | (grams) |
| Main | n-Octyl Acrylate | 236 | 212 | 0 | 0 | 0 |
| Monomer | | | | | | |
| Main | n-Decyl Acrylate | 0 | 0 | 200 | 0 | 0 |
| Monomer | | | | | | |
| Main | n-heptyl Acrylate | 0 | 0 | 0 | 200 | 0 |
| Monomer | | | | | | |
| Main | 2-Ethyl Hexyl | 0 | 0 | 0 | 0 | 314 |
| Monomer | Acrylate (petroleum | | | | | |
| | based monomer) | | | | | |
| Co- | Isobornylacrylate | 0 | 24 | 36 | 0 | 0 |
| monomer | | | | | | |
| Co- | 2-Hydroxy Ethyl | 2.04 | 2.04 | 2.04 | 2.04 | 3.20 |
| monomer | Methacrylate | | | | | |
| Co- | N-Vinyl | 0.20 | 0.20 | 0.20 | 0.20 | 0.32 |
| monomer | Pyrrolidone | | | | | |
| Co- | N K Ester M90G | 1.04 | 1.04 | 1.04 | 1.04 | 1.63 |
| monomer | | | | | | |
| Chain | t-Dodecyl | 0.10 | 0.10 | 0.10 | 0.81 | 0.10 |
| Transfer | Mercaptan | | | | | |
| Agent | | | | | | |
| Initiator | PERKODOX ® 16 | 0.24 | 0.24 | 0.24 | 0.20 | 0.32 |
| Initiator | LUPEROX ® A75 | 0.48 | 0.48 | 0.48 | 0.40 | 0.63 |
| Reaction | DI water | 286 | 286 | 286 | 242 | 258 |
| Medium | | | | | | |
| Surfactant | STEPANOL ® AMV | 2.13 | 2.13 | 2.13 | 1.8 | 2.36 |
| Surfactant | HITENOL ® BC-1025 | 2.39 | 2.39 | 2.39 | 2.02 | 2.64 |
| Polymeric | CYANAMER ® N-300 | 0.17 | 0.17 | 0.17 | 0.14 | 0.18 |
| Stabilizer | | | | | | |
| Co- | Na Styrene | 0.21 | 0.21 | 0.21 | 0.21 | 1.29 |
| Monomer | Sulfonate | | | | | |
| pH Buffer | Na Bicarbonate | 0.09 | 0.09 | 0.09 | 0.08 | 0.13 |

N K Ester M90G: Polyethylene oxide methacrylate from Shin Nakamura Chemical Company, Ltd. and Towa. Inc.
PERKODOX ® 16: Di(4-tert-butylcyclohexyl) peroxydicarbonate from Akzo Chemicals Inc.
LUPEROX ® A75: Benzoyl peroxide from Auto Fina
STEPANOL ® AMV: Ammonium lauryl sulfate from Stepan Co.
HITENOL ® BC-1025: Polyoxyethylene alkylphenyl ether ammonium sulfate from Montello Inc.
CYANAMER ® N-300: Polyacrylamide from Cytek

The microsphere adhesives of Examples 1 to 4 and Comparative Example C1 were compounded with a latex binder, CARBOTAC® 26222, and thickeners, KELZAN® S and ACRYSOL® TT935, according to Table 2. Viscosity of the MSA solutions was adjusted by the thickeners to be around 1000 to 3000 cps measured at 30 rpm by a Brookfield Viscometer. The compounded MSAs were coated on paper at a coat weight of 0.35 grams per square foot for evaluation.

TABLE 2
Compounding formulations of Example
1 to 4 and Comparative Example C1.

| | Example | | | | |
|---|---|---|---|---|---|
| Ingredients | 1 | 2 | 3 | 4 | C1 |
| Ex. 1 MSA | 400 | 0 | 0 | 0 | 0 |
| Ex. 2 MSA | 0 | 400 | 0 | 0 | 0 |
| Ex. 3 MSA | 0 | 0 | 400 | 0 | 0 |
| Ex. 4 MSA | 0 | 0 | 0 | 400 | 0 |
| Comparative | 0 | 0 | 0 | 0 | 400 |
| Ex. C1 MSA | | | | | |
| CARBOTAC ® 26222 | 16 | 16 | 16 | 16 | 16 |
| (Binder) | | | | | |
| KELZAN ® S | 0.43 | 0.43 | 0.43 | 0.43 | 0.43 |
| (Thickener) | | | | | |
| ACRYSOL ® TT935 | 2.65 | 2.65 | 2.65 | 2.65 | 2.65 |
| (Thickener) | | | | | |
| Sodium Hydroxide | 1.63 | 1.63 | 1.63 | 1.63 | 1.63 |
| (10% solution) | | | | | |

### Results:

TABLE 3
Adhesive performance and renewable content of Examples
1 to 4 and Comparative Example C1 at adhesive dry
coat weight of 0.35 grams per square foot.

| Composition | 1 | 2 | 3 | 4 | C1 |
|---|---|---|---|---|---|
| Initial adh. to micro | 51 | 62 | 36 | 43 | 53 |
| bond paper (g/in) | | | | | |
| Aged adh. to micro | 62 | 58 | 54 | 57 | 89 |
| bond paper (g/in) | | | | | |
| % Adhesion build up | 22% | 0% | 50% | 33% | 68% |
| on paper* | | | | | |
| Tack (gram) | 10 | 12 | 13 | 13 | 14 |
| Biobased Content in | 70 | 70 | 75 | 67 | 0 |
| MSA determined by | | | | | |
| ASTM D 6866-06a | | | | | |

*% Adhesion built up on paper is defined as % of (Aged adhesion to paper − Initial adhesion to paper)/Initial adhesion to paper. It is considered the adhesive has no adhesion build, i.e. 0%, if the calculated number is 0 or negative.

ASTM D 6866-06a, Standard Test Methods for Determining the Biobased Carbon Content of Natural Range Materials Using Radiocarbon and Isotope Ratio Mass Spectrometry Analysis, was used to determine biobased carbon content of Examples 1 to 4 and Comparative Example C1. The test results show the petroleum based adhesive, Comparative Example C1, contains 0% biobased carbon, and the renewable microsphere adhesives of Examples 1 to 4 contain 67 to 75% biobased carbon.

Adhesive performance of the renewable microsphere adhesive of Example 1 to 4 is as good as and in some cases better than the petroleum based 2-ethylhexylacrylate MSAs as shown by the results in Table 3. In particular, the adhesive of Comparative Example C1 had higher adhesion build on paper over time. In many applications, the increase in adhesion build is undesirable because more peel force is required to remove the sample from the surface to which it is attached.

Several patent applications and patents are cited herein; each is incorporated by reference herein in its entirety.

Various modifications and alterations of this invention will become apparent to those skilled in the art without departing from the scope and spirit of this invention.

What is claimed is:

1. An adhesive comprising a reaction product of (a) at least one polymerizable (meth)acrylate monomer derived at least in part from palm oil, coconut oil, tallow, or lard; (b) an initiator; and (c) a stabilizer, wherein the reaction occurs in water to yield a microsphere adhesive.

2. The adhesive of claim 1 wherein the polymerizable (meth)acrylate monomer is selected from the group consisting of n-C₆ to n-C₁₄ (meth)acrylates prepared by reacting one or more (meth)acrylic acids with one or more n-C₆, n-C₇, n-C₈, n-C₉, n-C₁₀, n-C₁₁, n-C₁₂, n-C₁₃, and n-C₁₄ alcohols derived from a non-petroleum resource.

3. The adhesive of claim 1 wherein said adhesive has a biobased carbon content of at least about 30%.

4. The adhesive of claim 1 wherein said adhesive has a biobased carbon content of at least about 40%.

5. The adhesive of claim 1 wherein said adhesive has a biobased carbon content of at least about 50%.

6. The adhesive of claim 1 wherein said adhesive has a biobased carbon content of at least about 65%.

7. The adhesive of claim 1 wherein the reaction product further comprises a surfactant.

8. The adhesive of claim 1 comprising from about 92.0 to 99.9 wt % of component (a), from about 0.01 to 4.0 wt % component (b); and from about 0.01 to 4 wt % of component (c), wherein the wt % of each component is based on the total weight of all the components.

9. A pressure sensitive adhesive composition comprising:
(a) microsphere adhesive comprising a reaction product of (i) one or more polymerizable monomer(s) derived at least in part from palm oil, coconut oil, tallow, or lard; (ii) one or more initiator(s); and (iii) one or more stabilizer(s), wherein the reaction occurs in water;
(b) a pressure sensitive adhesive binder; and
(c) a thickener.

10. The adhesive of claim 9 wherein the polymerizable (meth)acrylate monomer is selected from the group consisting of n-C₆ to n-C₁₄ (meth)acrylates prepared by reacting one or more (meth)acrylic acid with one or more n-C₆, n-C₇, n-C₈, n-C₉, n-C₁₀, n-C₁₁, n-C₁₂, n-C₁₃, and n-C₁₄ alcohols derived from a non-petroleum resource.

11. The composition of claim 9 comprising from about 90 to 98 wt % component (a), from about 1 to 10 wt % component (b), and from about 0.1 to 3.0 wt % component (c).

12. The composition of claim 11 disposed on at least a portion of a first surface of a backing selected from the group consisting of paper, polymeric film, woven fabric, non-woven fabric of synthetic or natural materials, metal, metallized polymeric film, and ceramic sheet.

13. An adhesive comprising a reaction product of:
(a) from about 92.0 to 99.9 wt % of one or more n-C₆ to n-C₁₄ (meth)acrylates prepared by reacting one or more (meth)acrylic acid with one or more n-C₆, n-C₇, n-C₈, n-C₉, n-C₁₀, n-C₁₁, n-C₁₂, n-C₁₃, and n-C₁₄ alcohols derived from a non-petroleum resource;
(b) from about 0.01 to 4.0 wt % of polymeric stabilizer; and
(c) from about 0.01 to 4.0 wt % of initiator; and
wherein the wt % of each component is based on the total of components (a) to (c) and wherein the reaction occurs in water to yield a microsphere adhesive.

14. The adhesive of claim 13, wherein one or more of the following was used in the reaction product per 100 parts by weight of the n-C₆ to n-C₁₄ (meth)acrylate content;
(1) up to about 75 parts by weight of at least one alkyl(meth)acrylate comonomer having from about 1 to 14 carbon atoms;
(2) up to about 30 parts by weight of at least one solute polymer;
(3) less than about 5 parts by weight of at least one polar comonomer;
(4) up to about 10 parts by weight of at least one amido comonomer;
(5) up to about 10 parts by weight of at least one polyethylene oxide (meth)acrylate comonomer;
(6) up to about 5 parts by weight of at least one ionic comonomer;
(7) up to about 1 parts by weight of at least one crosslinker; and
(8) up to 0.2 parts by weight of one or more chain transfer agents; and
(9) combinations thereof.

15. The adhesive of claim 9 further comprising up to about 0.2 wt %, based on the n-C₆ to n-C₁₄ (meth)acrylate content, of a chain transfer agent.

16. A microsphere adhesive composition comprising:
(a) from about 90 to 98 wt % of the microsphere adhesive of claim 9;
(b) from about 1 to 10 wt % of at least one binder; and
(c) from about 0.1 to 3.0 wt % of at least one thickener.

17. An adhesive article comprising the microsphere adhesive of claim 9 disposed on at least a portion of a first surface of a backing selected from the group consisting of paper, polymeric film, woven fabric, non-woven fabric of synthetic or natural materials, metal, metallized polymeric film, and ceramic sheet.

18. The article of claim 17 further comprising a release coating disposed on at least a portion of a second surface of the backing such that the release coating lies substantially opposing the adhesive composition.

19. An adhesive consisting of a reaction product of:
(a) from about 87 to 99.9 wt % of one or more n-C₆ to n-C₁₄ (meth)acrylate(s) prepared by reacting (meth)acrylic acid and one or more n-C₆, n-C₇, n-C₈, n-C₉, n-C₁₀, n-C₁₁, n-C₁₂, n-C₁₃, and n-C₁₄ alcohols derived from a non-petroleum resource;
(b) from about 0.01 to 5 wt % of at least one surfactant;
(c) from about 0.01 to 4 wt % of at least one polymeric stabilizer; and
(d) from about 0.01 to 4.0 wt % of at least one initiator;
wherein the wt % of each component is based on the total of components (a) to (d), with optionally, per 100 parts by weight of the n-C₆ to n-C₁₄ (meth)acrylate content, one or more of the following:
(e) up to about 75 parts by weight of at least one alkyl(meth)acrylate comonomer having from about 1 to 14 carbon atoms;
(f) less than about 5 parts by weight of at least one polar comonomer;
(g) up to about 10 parts by weight of at least one amido comonomer;
(h) up to about 10 parts by weight of at least one polyethylene oxide (meth)acrylate;
(i) up to about 30 parts by weight of at least one solute polymer; and
(j) up to about 0.2 parts by weight of at least one chain transfer agent,
(k) up to about 5 parts by weight of at least one ionic monomer;
(l) up to about 1 parts by weight of at least one crosslinker;
wherein the reaction occurs in water to yield a microsphere adhesive.

20. The adhesive of claim 19 wherein the alkyl(meth)acrylate comonomer is selected from the group consisting of isooctyl acrylate, isononyl(meth)acrylate, isoamyl(meth)acrylate, isodecyl(meth)acrylate, 2-ethylhexyl acrylate, n-butyl(meth)acrylate, sec-butyl(meth)acrylate, propyl(meth)acrylate, ethyl(meth)acrylate, methyl(meth)acrylate, isobornyl(meth)acrylate, 4-methyl-2-pentyl(meth)acrylate, 2-methylbutyl(meth)acrylate, t-butyl(meth)acrylate, and combinations thereof.

21. The adhesive of claim 19 wherein the polar comonomer is selected from the group consisting of (meth)acrylic acid, 2-hydroxyethyl(meth)acrylate, and combinations thereof.

22. The adhesive of claim 19 wherein the amido comonomer is selected from the group consisting of N-vinyl pyrrolidone, N-vinyl caprolactum, acrylamide, N,N-dimethyl acrylamide, and combinations thereof.

23. A microsphere adhesive composition comprising:
(a) from about 90 to 98 wt % of the microsphere adhesive of claim 15;
(b) from about 1 to 10 wt % of at least one binder; and
(c) from about 0.1 to 3.0 wt % of at least one thickener.

24. An adhesive article comprising the microsphere adhesive of claim 23 disposed on at least a portion of a first surface of a backing selected from the group consisting of paper, polymeric film, woven fabric, non-woven fabric of synthetic or natural materials, metal, metallized polymeric film, and ceramic sheet.

25. The article of claim 24 further comprising a release coating disposed on at least a portion of a second surface of the backing such that the release coating lies substantially opposing the adhesive composition.
